(19) United States
(12) Patent Application Publication
(10) Pub. No.: US 2008/0170526 A1
(43) Pub. Date: Jul. 17, 2008

(54) METHOD AND APPARATUS FOR EXTENDING STANDBY BATTERY LIFE OF A WIRELESS DEVICE

(75) Inventors: Mohit Narang, Escondido, CA (US); Amer Catovic, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/972,998

(22) Filed: Jan. 11, 2008

Related U.S. Application Data
(60) Provisional application No. 60/884,830, filed on Jan. 12, 2007.

(51) Int. Cl. G08C 17/00; H04B 1/38

(52) U.S. Cl. 370/311; 455/574

(57) ABSTRACT

An apparatus and method for extending the standby battery life of a wireless device by reading scheduling information to determine the time when the wireless device should be in the wake-up state to read system information, and going back to the sleep state until the start of the transmission of a new SIB broadcast cycle as determined based on the scheduling information.

### CLAIM OF PRIORITY UNDER 35 U.S.C. §119

The present Application for Patent claims priority to Provisional Application No. 60/884,830 entitled “Methods and Apparatus For Extending Standby Battery Life of a Wireless Device” filed Jan. 12, 2007, and assigned to the assignee hereof and hereby expressly incorporated by reference herein.

### FIELD

This disclosure relates generally to methods and apparatus for extending standby battery life. More particularly, the disclosure relates to extending standby battery life of a wireless device.

### BACKGROUND

Battery life of wireless devices is one of the major concerns for wireless network operators and one of the main parameters describing user experience with new wireless devices. In one example, the current trend of wireless communication systems is the migration from second generation (2G) systems to third generation (3G) systems. The 3G systems provide greater capacity and broadband wireless capabilities and hence, minimizing energy consumption is an even more major concern. One emerging 3G system is Universal Mobile Telecommunications Systems (UMTS). Many wireless carriers are upgrading their networks to include 3G capabilities, particularly in dense urban areas, while maintaining broader coverage using existing 2G networks.

In current implementations, when in sleep state, the wireless device wakes up in regular time intervals to read system information which is broadcasted by the network. There is a variety of system information that is broadcasted, which is partitioned into system information blocks (SIB). For example each SIB carries a particular type of network information, such as but not limited to, Public Land Mobile Network (PLMN) info, DRX cycle coefficient (SIB1), thresholds for cell reselection (SIB3), current uplink interference level (SIB7), paging frequency, etc. The broadcast scheduling of these system information blocks is contained in the master information block (MIB) which is broadcasted in regular, pre-determined time intervals. MIB contains the exact repetition count, number of segments and system frame number for each of the SIBs broadcasted.

Each wireless device aims to extend its battery life between charging to maximize user satisfaction. One commonly used technique to extend battery life is to place the wireless device in a sleep state. While in the sleep state, the wireless device periodically reverts to a wake-up state to receive network information and/or to send information back to the network. In particular, the wireless device needs to be in the wake-up state to receive SIBs from the network. For example, before a wireless device can reselect to or camp on a new cell, it needs to be in the wake-up state to receive and decode all the SIBs broadcasted by that cell. When the wireless device is in the wake-up state, its current energy consumption is significantly larger than in the sleep state. Therefore, it is highly beneficial for the wireless device to stay in the sleep state as long as possible and reduce the time it spends in the wake-up state.

### SUMMARY

Disclosed is an apparatus and method for extending standby battery life of a wireless device. According to one aspect, a method for extending the standby battery life of a wireless device comprises reading scheduling information to determine the time when the wireless device should be in the wake-up state to read system information, and going back to the sleep state until the start of the transmission of a new SIB broadcast cycle as determined based on the scheduling information.

According to another aspect, a method for extending the standby battery life of a wireless device comprises reading scheduling information to determine the time when the wireless device should be in the wake-up state to read system information, determining a start of a transmission of a new SIB broadcast cycle based on the scheduling information, and putting the wireless device in a wake-up state at the start of the transmission of the new SIB broadcast cycle.

According to another aspect, a wireless device comprising a processor and memory, the memory containing program code executable by the processor for performing the following: reading scheduling information to determine the time when the wireless device should be in the wake-up state to read system information, and going back to the sleep state until the start of the transmission of a new SIB broadcast cycle as determined based on the scheduling information.

According to another aspect, a wireless device comprising a processor and memory, the memory containing program code executable by the processor for performing the following: reading scheduling information to determine the time when the wireless device should be in the wake-up state to read system information, determining a start of a transmission of a new SIB broadcast cycle based on the scheduling information, and putting the wireless device in a wake-up state at the start of the transmission of the new SIB broadcast cycle.

According to another aspect, a computer-readable medium including program code stored thereon, comprises program code for causing a computer to read scheduling information to determine the time when the computer should be in the wake-up state to read system information, and program code for causing the computer to go back to the sleep state until the start of the transmission of a new SIB broadcast cycle as determined based on the scheduling information.

According to another aspect, a computer-readable medium including program code stored thereon, comprises program code for causing a computer to read scheduling information to determine the time when the computer should be in the wake-up state to read system information, program code for causing the computer to determine a start of a transmission of a new SIB broadcast cycle based on the scheduling information, and program code for causing the computer to put itself in a wake-up state at the start of the transmission of the new SIB broadcast cycle.

According to another aspect, an apparatus for extending the standby battery life of a wireless device comprises means for reading scheduling information to determine the time when the wireless device should be in the wake-up state to read system information, and means for going back to the sleep state until the start of the transmission of a new SIB broadcast cycle as determined based on the scheduling information.

According to another aspect, an apparatus for extending the standby battery life of a wireless device comprises means for reading scheduling information to determine the time when the wireless device should be in the wake-up state to read system information, means for determining a start of a transmission of a new SIB broadcast cycle based on the scheduling information, and means for putting the wireless device in a wake-up state at the start of the transmission of the new SIB broadcast cycle.

One advantage of the present disclosure is reducing (i.e., energy) consumption of the wireless device by efficiently determining when the wireless device must be in the wake-up state and minimizing the duration of the wireless device's wake-up state.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates the sleep cycle of the user equipment in idle mode.

FIG. 2 illustrates an example of the SIB scheduling in a commercial UMTS network.

FIG. 3 illustrates an exemplary interface in the network between the radio resource control (RRC) layer and the physical layer (PL).

FIG. 4 illustrates an exemplary Inter-SIB sleep management algorithm.

FIG. 5 and FIG. 6 show two respective examples of SIB scheduling in commercially deployed networks.

FIG. 7 illustrates the standby battery time gain for two exemplary Networks B and C, with respect to a third exemplary Network A for two different example reselection rates.

FIG. 8 illustrates the standby battery time improvement using ISMA.

FIG. 9 illustrates an exemplary device comprises a processor in communication with a memory for executing the processes for extending standby battery life.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

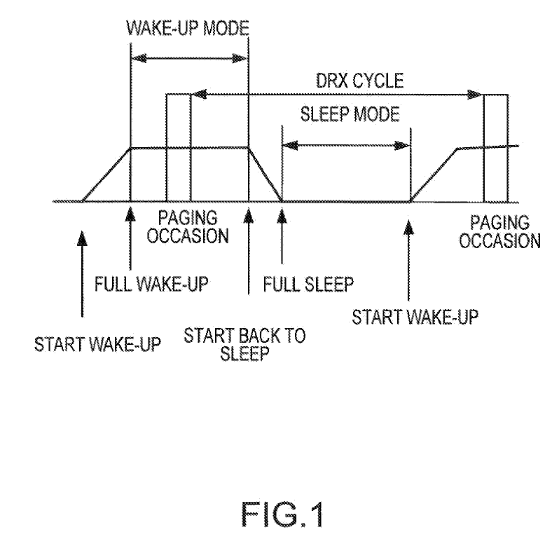

In wireless networks (for example UMTS networks), one of the possible modes that a wireless device (a.k.a. user equipment or UE) can be in idle mode. The idle mode is characterized by the absence of signaling connection with the network. While in idle mode, the UE is either in the sleep state or in the wake-up state. In the sleep state, the UE shuts down its RF circuitry, and maintains no physical channels. However, while in the sleep state, the UE will periodically “wake up” into the wake-up state in order to demodulate the Paging Indicator Channel (PICH) and evaluate the signal quality of the camping cell and the neighboring cells. The UE “wakes up” into the wake-up state during its periodic paging occasions, whose timing depends on the UE identifier called IMSI (International Mobile Subscriber Identity). This ensures equal spread of paging occasions in time. The frequency of paging occasions is determined by the network parameter, called DRX Cycle Coefficient, which is included in the system information broadcast on the Broadcast Common Control Channel (BCCH) to all devices in a given cell. FIG. 1 illustrates the sleep cycle of the UE in idle mode. The sleep cycle of the UE is controlled by the physical layer functions in the UE, based on the IMSI and the DRX cycle coefficient received from the network and handed down to the physical layer by way of the radio resource control (RRC) layer.

One of the outcomes of evaluating the quality of the camping and neighboring cells is to determine whether to remain camped on that cell or the decision to reselect to a new cell. This determination process employs standard cell reselection parameters which may include (for example) the signal quality thresholds for initiating measurements of the neighboring cell signals, signal quality thresholds and hysteresis offsets for triggering reselection to a new cell and the timers. If the determination is to reselect to a new cell, the UE will need to read the necessary system information broadcasted on the BCCH of the new cell.

The system information broadcasted on BCCH is partitioned into SIBs. Each SIB carries particular type of system information, such as but not limited to, Public Land Mobile Network (PLMN) info, DRX cycle coefficient (SIB1), thresholds for cell reselection (SIB3), current uplink interference level (SIB7), paging frequency, etc. In one aspect, each SIB is segmented and transmitted over several BCCH frames and is repeated periodically with the fixed period, called repetition count, expressed, for example, in number of system frames. In one example, the duration of one system frame is 10 ms. The size of SIBs varies depending on the information they carry. For example, SIB11 carries the list of neighbors of the camping cell that the UE is supposed to measure for cell reselection purposes. The SIB size and number of segments will be affected by the number of neighbors of the camping cell.

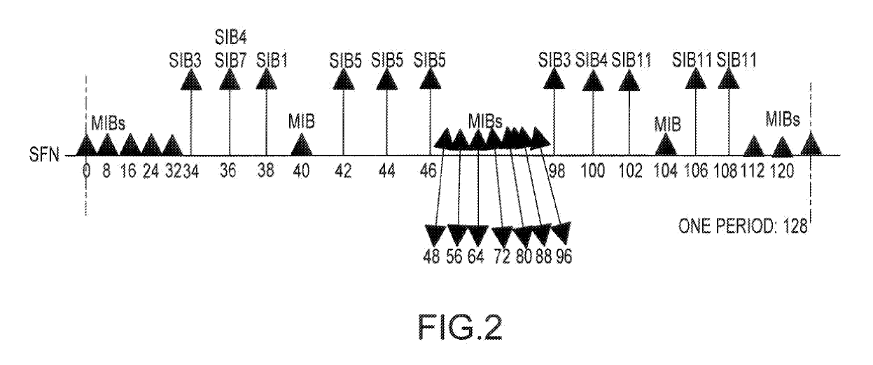

The system information relating to the scheduling of SIBs onto, for example, 20 ms-long BCCH frames is contained in the master information block (MIB), which is broadcasted in the regular, pre-determined time intervals of, for example, 80 ms (i.e. every fourth BCCH frame). MIB contains the exact repetition count, number of segments, System Frame Number (SFN) of the first segment and SFN offset for the remaining segments (if any) for each of the SIBs. In one aspect, in addition to MIB, scheduling blocks (SB) are included which contain the system information for the rest of the SIBs that were not included in the MIB. One example of the SIB scheduling in a commercial UMTS network, denoted as Network A, is shown in FIG. 2.

In the example shown in FIG. 2, SIB3 and SIB4 consist of one segment each, with repetition count of 64; SIB5 and SIB11 consist of three segments each and have repetition count of 128. Upon reselection to a new cell, but before the UE can camp on the new cell, the UE needs to have all the SIBs broadcasted by that cell. In the example of Network A, the maximum repetition count across all SIBs is 128. Therefore, it will take the UE about 1.28 seconds to collect all the SIBs in the new cell.

In one aspect, decoding and managing of the information broadcasted on the BCCH is the task of the Radio Resource Control (RRC) layer in the UE. The RRC will read the SIB scheduling info from MIBs, collect and reassemble SIB segments and decode the system information parameters contained therein.

In general, there is a tradeoff between the standby battery life and the idle mode performance of mobile devices (i.e., user equipments) in wireless networks. For example, standard parameters affecting cell reselection, will impact the battery life since SIB collection is required upon cell reselection. Consider the SIB scheduling example shown in FIG. 2. In one example, the UE is in the wake-up state and decides to reselect to a new cell whose SIB information it does not yet have. Assume that the UE starts demodulating the new cell's BCCH (denoted as N-BCCH) at the time of SFN48. The UE will first acquire the MIB scheduled at SFN 48 with the scheduling information for all the SIBs. The next information broadcasted on the N-BCCH will be SIB3 at SFN 98. In this example, if the UE stays in the wake-up state during this entire time (500 ms), it will drain its battery at a faster rate than in the sleep state. As an example, assume that the ratio of the current drawn by the UE when in the wake-up state to the current drawn when in the sleep state is 25. This means that each SIB collection will reduce the standby battery life of the UE by about 24×1.28≅30 seconds. Therefore, the maximum repetition count is an important parameter affecting the battery life of the UE.

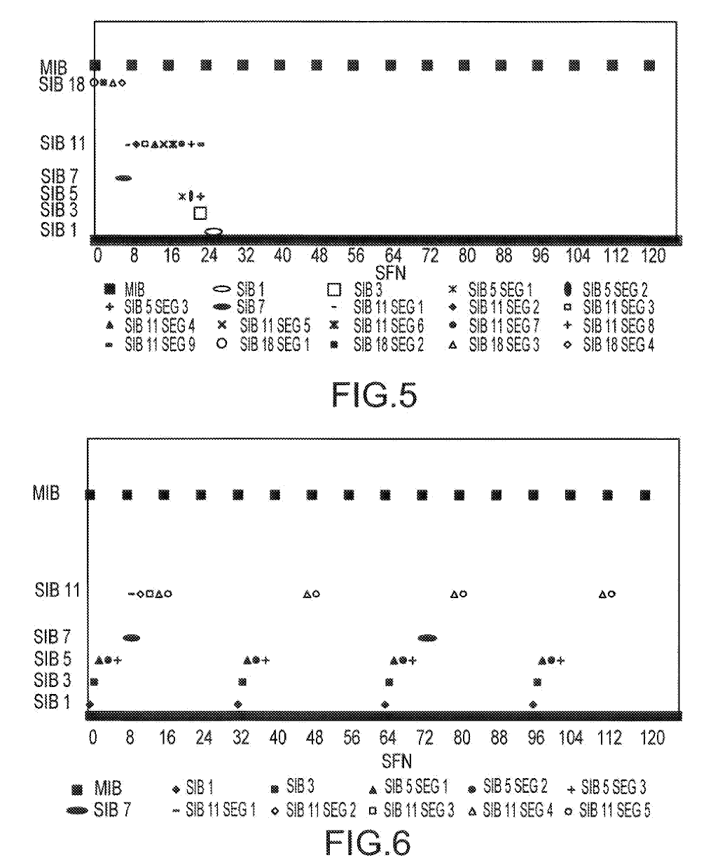

It would be advantageous for the UE to go to sleep state until the SIB3 broadcast starts. However, after the UE reads the first segment of SIB11 at SFN 102, there is only 40 ms until the broadcast of the second segment of SIB11 at SFN 106. This time gap may not be sufficient for the UE to complete the sleep cycle as shown in FIG. 1. The ISMA algorithm shown in FIG. 4 allows the UE to detect the opportunities to go into sleep state without missing a SIB broadcast, thus allowing the UE to minimize energy consumption.

Additionally, frequent updating by the network of the SIBs on BCCH is beneficial. For example, frequent broadcast of SIB7, which contains the current uplink interference level, helps to reduce the mobile-terminated call setup time. It is necessary for the UE to have the current uplink interference information in order to determine the appropriate initial transmit power. Also, the time required to acquire all SIBs upon reselection of a new cell or upon change of the MIB value tag is reduced if SIBs are broadcasted more often. The activity factor for BCCH is 100% regardless of the SIB scheduling scheme. However, the throughput of BCCH is limited to 12.2 kbps which practically limits the frequency of SIB broadcasts due to the constrained data rate.

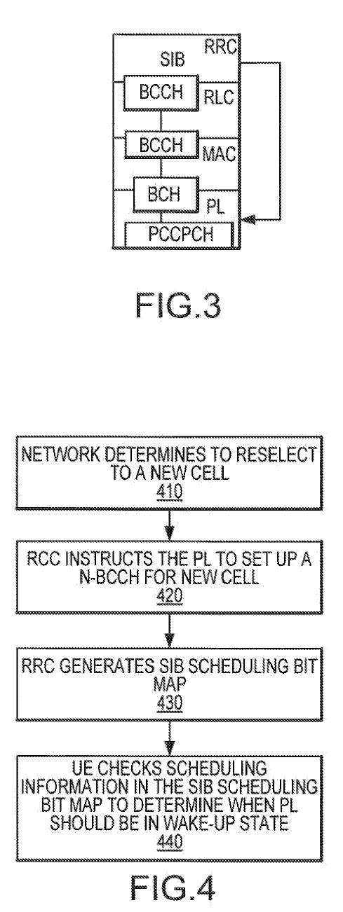

FIG. 3 illustrates an exemplary interface in the network between the radio resource control (RRC) layer and the physical layer (PL). As shown in FIG. 3, the inter-SIB sleep management algorithm (ISMA) includes an ISMA interface for triggering of the UE sleep cycle by the PL based on the SIB scheduling information provided by the RRC layer. This allows the UE to take advantage of the opportunities to go into sleep state between reading SIBs. Through the ISMA interface, the RRC layer informs the PL of the SIB scheduling information so that the PL can compute the time to initiate sleep state and the time to initiate wake-up state. In one aspect, other SIBs are also decoded and the associated system information is passed along to the PL. The SIB scheduling bit map is used by the PL to control and manage the sleep state of the UE. In one aspect, SIB scheduling information includes offset, repetition period, the number of segments for each SIB, and other scheduling related information.

FIG. 4 illustrates an exemplary Inter-SIB sleep management algorithm (ISMA) 400. In block 410, the Network determines to reselect to a new cell. In one aspect, the determination is made by the RRC within the Network. From block 410, proceed to block 420. In one aspect, if the Network determines not to reselect to a new cell, either stop or re-determine whether to reselect to a new cell after a wait time. One skilled in the art would understand that the wait time can have a fixed, predetermined value set by system parameters, by particular applications, by an operator or by a user. In block 420, the RRC instructs the PL to set up a BCCH for the new cell (denoted as N-BCCH). Following block 420, in block 430, the RRC generates a SIB Scheduling Bit Map based on the new cell. In the UE, the SIB Scheduling Bit Map is read for the scheduling information to determine the time when the UE should be in the wake-up state to read system information. In one aspect, after the reading of the system information, the UE goes back to the sleep state until the start of the transmission of a new SIB broadcast cycle as determined based on the scheduling information in the SIB Scheduling Bit Map. In one aspect, the start of a transmission of a new SIB broadcast cycle based on the scheduling information is determined so as to put the UE in a wake-up state at the start of the transmission of the new SIB broadcast cycle.

In one aspect, the SIB Scheduling Bit Map consists of 2048 memory locations each carrying a value of 1 or 0. The size of the SIB Scheduling Bit Map is set at 2048 since SFN is a 12-bit number and rolls over at 4096. In one aspect, a value of 1 in a memory location n (n=0.2047) indicates that there is a SIB scheduled during the N-BCCH frame spanning SFN 2n and 2n+1. This would impose that the PL should be in a wake-up state and decode the N-BCCH during SFN 2n and 2n+1. In one aspect, a value of 0 in a memory location n (n=0.2047) indicates that there is no SIB scheduled during the N-BCCH frame spanning SFN 2n and 2n+1. The PL can then be in the sleep state since it is not required to decode the N-BCCH during SFN 2n and 2n+1. The RRC notifies the PL when the SIB Scheduling Bit Map is generated.

In one aspect, the RRC updates the SIB Scheduling Bit Map and notifies the PL of the updates in at least the following two situations: 1) There is a new SIB scheduled, as specified in the MIBs. In this situation, the appropriate memory location is set to 1. 2) A SIB is successfully received by the RRC. In this situation, the appropriate memory location corresponding to the received SIB is set to 0. And, once the PL has indication that the SIB Scheduling Bit Map is generated or has been updated, the SIB Scheduling Bit Map is checked, in block 440, to determine when the PL should be in wake-up state or in the sleep state. In one aspect, the PL uses the ramp-up and ramp-down times for PICH and N-BCCH (see FIG. 1), the SFN of the next SIB (based on the SIB Scheduling Bit Map) and the SFN of the next paging occasion to compute (and update as needed) the time to initiate sleep state and the time to initiate wake-up state.

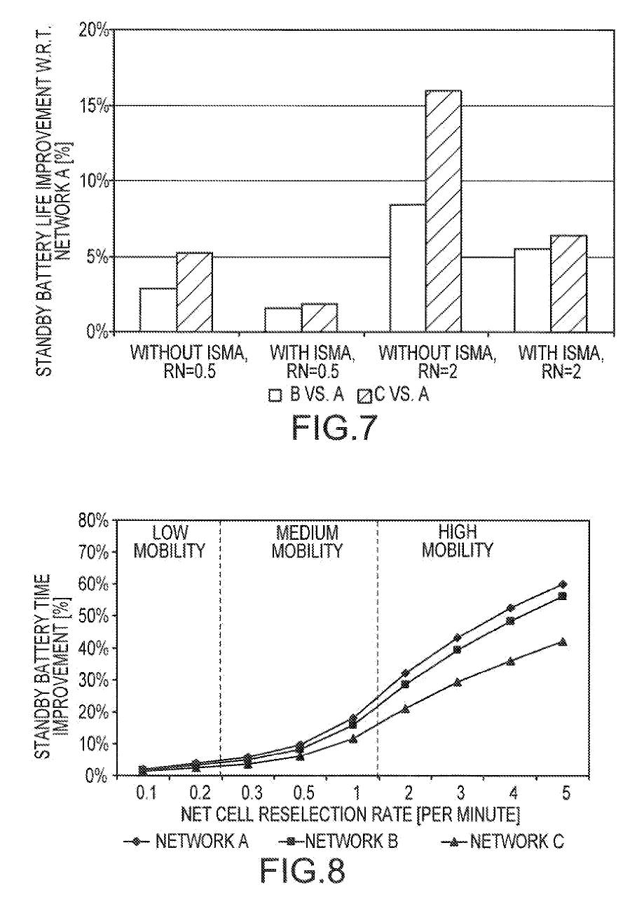

FIG. 5 and FIG. 6 show two examples of SIB scheduling in commercially deployed networks, denoted as Network B and Network C, respectively. All three networks shown in FIGS. 2, 5 and 6 use the maximum repetition count of 128 and the DRX cycle duration T_{DRX} of 1.28 s. To evaluate performance, first, compute the SIB collection times without and with ISMA, respectively. Second, define the SIB collection time as the time required for the UE to spend in the wake-up state in order to collect the necessary SIBs on the new cell. Third, use the results to analyze the relationship between the SIB scheduling schemes and the standby battery time of UE with and without ISMA for various user mobility patterns.

To first evaluate performance without ISMA, consider the SIB scheduling of Network A shown in FIG. 2. In this example, assume the UE starts SIB collection at a time between SFN 0 and 32. The UE will then complete the collection of all SIBs at SFN 110. If, however, assume the start time is between SFN 96 and 128, the collection will be completed at SFN 128+110=238. Based on FIG. 2, the minimum and maximum SIB collection times without ISMA for Network A are:

Tₘᵢₙ^{A}=1100 ms−320 ms+τ₁+τ₂=850 ms (1)

Tₘₐₓ^{A}=2380 ms−960 ms+τ₁+τ₂=1490 ms (2)

where τ₁ and τ₂ are the ramp-up and ramp-down times. In this example, assume τ₁ and τ₂ to be 40 ms and 30 ms, respectively. Since the SIB collection start time depends on the cell reselection time, it can be considered to have a uniform distribution. The average SIB collection time is computed by evaluating SIB collection times and averaging them over uniformly distributed start times. Table 1 shows the maximum, minimum and average SIB collection times without ISMA for Networks A, B and C. The values shown in Table 1 suggest that SIB scheduling schemes have significant impact on the time the UE spends collecting SIBs upon cell reselection. This is important for wireless operators using different infrastructure vendors in different areas since it suggests that the UE might experience different standby battery times in different areas.

TABLE 1
SIB Collection Times without ISMA

| Network | Tₘᵢₙ | Tₘₐₓ | T_{avg} |
|---|---|---|---|
| A | 850 ms | 1490 ms | 1175 ms |
| B | 350 ms | 1490 ms | 953 ms |
| C | 250 ms | 1430 ms | 781 ms |

Next, to evaluate performance with ISMA, compute the SIB collection times with ISMA. First, take into consideration that the UE will go to sleep state whenever the time until the next scheduled SIB is greater than or equal to the sum of the ramp-up time, ramp-down time and one system frame, i.e. τ₁+τ₂+10 ms=80 ms. Second, compute the SIB collection times for the SIB scheduling schemes in Networks A, B and C. As shown in Table 2, the SIB collection times show significant improvement compared to the values in Table 1. The average SIB collection times and their respective ranges are reduced. From Table 2, it shows that ISMA reduces the impact of SIB scheduling schemes on SIB collection times, since the difference between different network implementations (i.e., Networks A, B and C) are also reduced.

TABLE 2
SIB COLLECTION TIMES WITH ISMA

| Network | Tₘᵢₙ | Tₘₐₓ | T_{avg} |
|---|---|---|---|
| A | 380 ms | 530 ms | 480 ms |
| B | 350 ms | 540 ms | 367 ms |
| C | 250 ms | 410 ms | 350 ms |

Typically, a UE collects all the SIBs upon the following four events:

1. When the UE is powered-up

2. When a MIB value tag changes

3. When the out-of-service condition occurs

4. When a cell reselection occurs

The frequency of occurrence of the first and second events during battery time duration is sufficiently low and therefore the impact of the first and second events on the battery life is typically negligible. The third event typically occurs more frequently and usually only in bad coverage conditions. In this case, the optimization of the coverage would reduce the frequency of this event. In addition to this, the user experience in this case would probably be more affected by the lack of service than the battery life. Consequently, the focus is on the fourth event as it is the most frequent in occurrence and has the most significant impact on battery life.

Each time the UE reselects to a new cell whose valid system information it does not have, the UE will need to collect all the SIBs of that new cell. During the SIB collection time, the UE will need to transition from the sleep state to the wake-up state. The longer the SIB collection time, the more time the UE spends in the wake-up state, and thus consuming more battery energy. The standby time of the UE is expressed as

$$ST = \frac{B}{{f}_{a} {I}_{a} + ( 1 - {f}_{a} ) {I}_{s}} \qquad ( 3 )$$

where B denotes the battery capacity, Iₐ and Iₛ denote the current drawn by the UE when in the wake-up state and in the sleep state, respectively, and fₐ denotes the fraction of time the UE is in the wake-up state.

In two implementation examples i and j, the standby time gain of i with respect to j is expressed as:

$${γ}_{i / j} = \frac{{ST}_{i}}{{ST}_{j}} - 1 = \frac{1 + {f}_{a , j} ( α - 1 )}{1 + {f}_{a , i} ( α - 1 )} - 1 \qquad ( 4 )$$

where α=Iₐ/Iₛ. The fraction of time the UE spends in the wake-up state is then expressed as:

$${f}_{a , i} = \frac{{T}_{awake}^{i}}{{T}_{DRX}} = \frac{( {T}_{c} + {T}_{avg}^{i} {R}_{n} )}{{T}_{DRX}} m s / DRX cycle \qquad ( 3 )$$

where T_{c} is the time UE spends for PICH decoding and cell quality measurements. T_{avg} is as defined in Tables 1 and 2. Rₙ is the net average reselection rate per DRX cycle duration. Alternatively, for a given network with fixed T_{DRX}, Rₙ can be expressed as the net average cell reselection rate per minute or per hour. Rₙ can be further factored as:

Rₙ=r·R (6)

where R is the average cell reselection rate, and r is the fraction of the reselections that require SIB collection, which is directly related to the UE capacity of storing the SIBs of the recently visited cells for a certain time.

Equations (4) and (5) show that γ_{i/j} depends greatly on the net reselection rate Rₙ. However, UE users with quite different usage patterns may have similar Rₙ since r and R are independent parameters that can have wide range of combinations ending in similar products. For example, a constantly mobile UE user (i.e. high R) who spends all his time within the areas of few cells (low r) could have a standby battery time similar to another UE user who moves rarely (low R) but within a larger geographic area (high r). Similarly, a UE user who is not moving half of the time and is moving during the other half, experiencing cell reselections at the rate of one per minute, will experience similar battery life to another UE user who is constantly moving and experiences cell reselections at the rate of one per two minutes, provided they both move within the same area. Another important factor impacting Rₙ is the cell area size. For example, UE users in highly dense urban areas will have Rₙ higher than UE users in rural areas.

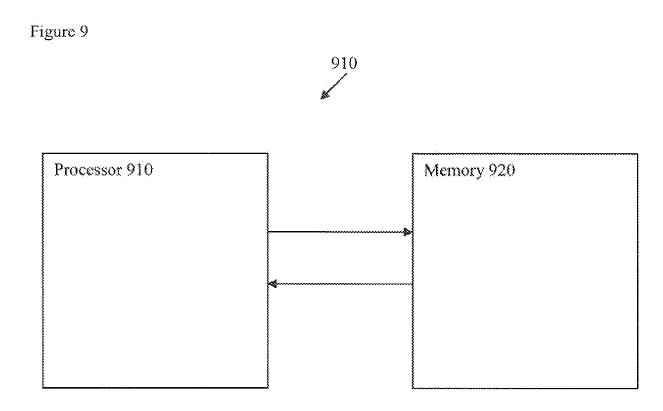

FIG. 7 illustrates the standby battery time gain for Networks B and C, with respect to Network A, for two different values of Rₙ (expressed in reselections per minute). T_{c} and α are set to typical values of 25 ms and 25, respectively. FIG. 7 illustrates the impact of the SIB scheduling schemes on the standby battery time of the UE. The SIB scheduling scheme in Network A results in inferior standby battery time for UE compared to Networks B and C. This is the case with or without ISMA,. However, with ISMA, the impact of the SIB scheduling schemes on the standby battery time is reduced. FIG. 7 also shows that higher Rₙ yields higher differences. Thus, the graphical results suggest that the impact on the standby battery life is a key consideration in the design of the SIB scheduling schemes.

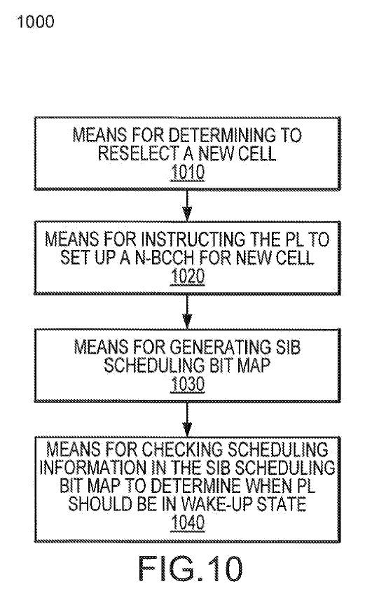

FIG. 8 illustrates the standby battery time improvement using ISMA. FIG. 8 shows γ_{i/j} for Networks A, B and C versus the net reselection rate Rₙ, where i and j denote the implementations with ISMA and without ISMA, respectively. The graphs shown in FIG. 8 indicate that for highly mobile UE users, UEs with ISMA could experience battery life gains of up to 50%. And, the improvement is substantial similar for UE users with medium mobility, such as UE users who are highly mobile for a fraction of the battery life duration.

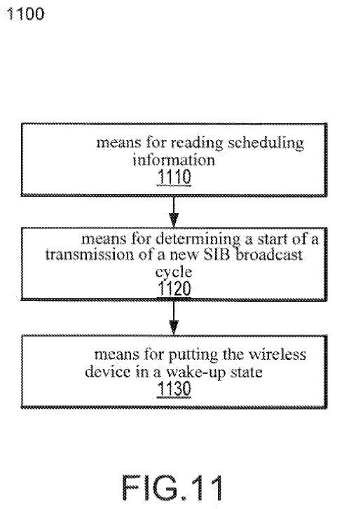

The various illustrative flow diagrams, logical blocks, modules, and/or circuits described herein may be implemented or performed with one or more processors. In one aspect, a processor is coupled with a memory which stores data, meta data, program instructions, etc. to be executed by the processor for implementing or performing the various flow diagrams, logical blocks, modules, and/or circuits described herein. FIG. 9 illustrates an exemplary device 900 comprising a processor 910 in communication with a memory 920 for executing the processes for extending standby battery life. In one example, the device 900 is used to implement the algorithm illustrated in FIG. 4. In one aspect, the memory 920 is located within the processor 910. In another aspect, the memory 920 is external to the processor 910. A processor may be a general purpose processor, such as a microprocessor, a specific application processor, such a digital signal processor (DSP), or any other hardware platform capable of supporting software. Software shall be construed broadly to mean any combination of instructions, data structures, or program code, whether referred to as software, firmware, middleware, microcode, or any other terminology. Alternatively, a processor may be an application specific integrated circuit (ASIC), a programmable logic device (PLD), a field programmable gate array (FPGA), a controller, a micro-controller, a state machine, a combination of discrete hardware components, or any combination thereof. The various illustrative flow diagrams, logical blocks, modules, and/or circuits described herein may also include computer readable medium for storing software. The computer readable medium may also include one or more storage devices, a transmission line, or a carrier wave that encodes a data signal.

FIGS. 10 illustrates an exemplary device 1000 comprising modules or means for carrying out the acts shown in FIG. 4, as described above. FIGS. 11 illustrates an exemplary device 1100 comprising modules or means for carrying out one embodiment as described above.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for extending the standby battery life of a wireless device comprising:
reading scheduling information to determine the time when the wireless device should be in the wake-up state to read system information; and
going back to the sleep state until the start of the transmission of a new SIB broadcast cycle as determined based on the scheduling information.

2. The method of claim 1 wherein the scheduling information is located within a SIB Scheduling Bit Map.

3. The method of claim 2 wherein the SIB Scheduling Bit Map consists of 2048 memory locations each with a value to indicate whether or not a SIB (system information block) is scheduled to be broadcast.

4. The method of claim 3 wherein the wireless device determines its wake-up state or sleep state based on the value.

5. The method of claim 1 wherein the scheduling information is broadcast as part of the MIB (master information block).

6. The method of claim 5 wherein the MIB is broadcast on a BCCH (Broadcast Common Control Channel).

7. The method of claim 6 wherein the scheduling information includes at least one of the following for each of a plurality of SIBs (system information blocks): offset, repetition period or the number of segments.

8. The method of claim 7 further comprising reading system information from at least one of the plurality of SIBs.

9. The method of claim 8 wherein the system information includes at least one of the following: Public Land Mobile Network (PLMN) info, DRX cycle coefficient (SIB1), thresholds for cell reselection (SIB3), current uplink interference level (SIB7), paging frequency.

10. The method of claim 1 further comprising determining to reselect to a new cell prior to reading the scheduling information.

11. The method of claim 10 further comprising instructing a physical layer to set up a BCCH for the new cell after determining to reselect to the new cell.

12. The method of claim 11 wherein a RRC (radio resource control) performs the determining process to reselect to the new cell.

13. The method of claim 12 further comprising receiving the scheduling information as part of a MIB (master information block) and generating a SIB Scheduling Bit Map containing the scheduling information.

14. The method of claim 13 wherein the RRC updates the SIB Scheduling Bit Map and notifies the physical layer of the updates.

15. The method of claim 14 wherein the physical layer is notified of the updates if one of the following occurs: a SIB (system information block) is newly scheduled as specified in the MIB or a SIB is successfully received by the RRC.

16. The method of claim 15 wherein the SIB Scheduling Bit Map consists of 2048 memory locations each with a value to indicate whether or not the SIB is scheduled to be broadcast.

17. The method of 16 wherein the value of at least one of the 2048 memory locations is changed.

18. The method of claim 13 wherein the SIB Scheduling Bit Map consists of 2048 memory locations each with a value to indicate whether or not a SIB (system information block) is scheduled to be broadcast.

19. The method of claim 18 wherein the wireless device determines its wake-up state or sleep state based on the value.

20. The method of claim 13 wherein the MIB is broadcast on the BCCH.

21. The method of claim 20 wherein the scheduling information includes at least one of the following for each of a plurality of SIBs (system information blocks): offset, repetition period or the number of segments.

22. A method for extending the standby battery life of a wireless device comprising:
reading scheduling information to determine the time when the wireless device should be in the wake-up state to read system information;
determining a start of a transmission of a new SIB broadcast cycle based on the scheduling information; and
putting the wireless device in a wake-up state at the start of the transmission of the new SIB broadcast cycle.

23. The method of claim 22 wherein the scheduling information is broadcast as part of a MIB (master information block).

24. The method of claim 23 wherein the MIB is broadcast on a BCCH (Broadcast Common Control Channel).

25. A wireless device comprising a processor and memory, the memory containing program code executable by the processor for performing the following:
reading scheduling information to determine the time when the wireless device should be in the wake-up state to read system information; and
going back to the sleep state until the start of the transmission of a new SIB broadcast cycle as determined based on the scheduling information.

26. The wireless device of claim 25 wherein the memory further comprising program code for determining to reselect to a new cell prior to reading the scheduling information.

27. The wireless device of claim 26 wherein the memory further comprising program code for instructing a physical layer to set up a BCCH for the new cell after determining to reselect to the new cell.

28. The wireless device of claim 27 wherein the memory further comprising program code for receiving the scheduling information as part of a MIB (master information block) and generating a SIB Scheduling Bit Map containing the scheduling information.

29. The wireless device of claim 28 wherein the scheduling information includes at least one of the following for each of a plurality of SIBs (system information blocks): offset, repetition period or the number of segments.

30. A wireless device comprising a processor and memory, the memory containing program code executable by the processor for performing the following:
reading scheduling information to determine the time when the wireless device should be in the wake-up state to read system information;
determining a start of a transmission of a new SIB broadcast cycle based on the scheduling information; and
putting the wireless device in a wake-up state at the start of the transmission of the new SIB broadcast cycle.

31. A computer-readable medium including program code stored thereon, comprising:
program code for causing a computer to read scheduling information to determine the time when the computer should be in the wake-up state to read system information; and
program code for causing the computer to go back to the sleep state until the start of the transmission of a new SIB broadcast cycle as determined based on the scheduling information.

32. The computer-readable medium of claim 31 further comprising program code to cause the computer to determine to reselect to a new cell prior to reading the scheduling information.

33. The computer-readable medium of claim 32 further comprising program code to cause the computer to instruct a physical layer to set up a BCCH for the new cell after determining to reselect to the new cell.

34. The computer-readable medium of claim 33 further comprising program code to cause the computer to receive the scheduling information as part of a MIB (master information block) and to generate a SIB Scheduling Bit Map containing the scheduling information.

35. The computer-readable medium of claim 34 wherein the scheduling information includes at least one of the following for each of a plurality of SIBs (system information blocks): offset, repetition period or the number of segments.

36. A computer-readable medium including program code stored thereon, comprising:
program code for causing a computer to read scheduling information to determine the time when the computer should be in the wake-up state to read system information;
program code for causing the computer to determine a start of a transmission of a new SIB broadcast cycle based on the scheduling information; and
program code for causing the computer to put itself in a wake-up state at the start of the transmission of the new SIB broadcast cycle.

37. An apparatus for extending the standby battery life of a wireless device comprising:
means for reading scheduling information to determine the time when the wireless device should be in the wake-up state to read system information; and
means for going back to the sleep state until the start of the transmission of a new SIB broadcast cycle as determined based on the scheduling information.

38. The apparatus of claim 37 further comprising means for determining to reselect to a new cell prior to reading the scheduling information.

39. The apparatus of claim 38 further comprising means for instructing a physical layer to set up a BCCH for the new cell after determining to reselect to the new cell.

40. The apparatus of claim 39 further comprising means for receiving the scheduling information as part of a MIB (master information block) and means for generating a SIB Scheduling Bit Map containing the scheduling information.

41. The apparatus of claim 40 wherein the scheduling information includes at least one of the following for each of a plurality of SIBs (system information blocks): offset, repetition period or the number of segments.

42. An apparatus for extending the standby battery life of a wireless device comprising:
means for reading scheduling information to determine the time when the wireless device should be in the wake-up state to read system information;
means for determining a start of a transmission of a new SIB broadcast cycle based on the scheduling information; and
means for putting the wireless device in a wake-up state at the start of the transmission of the new SIB broadcast cycle.
